(19) United States
(12) Patent Application Publication
(10) Pub. No.: US 2021/0066736 A1
(43) Pub. Date: Mar. 4, 2021

(54) FUEL CELL SYSTEM AND METHOD FOR CONTROLLING THE SAME

(71) Applicant: TOYOTA JIDOSHA KABUSHIKI KAISHA, Toyota-shi (JP)

(72) Inventors: Satoshi SHIOKAWA, Okazaki-shi (JP); Shinji ASO, Toyota-shi (JP)

(21) Appl. No.: 16/896,555

(22) Filed: Jun. 9, 2020

(30) Foreign Application Priority Data
Sep. 4, 2019 (JP) 2019-160925

(51) Int. Cl. H01M 8/04858; H01M 8/04537; H01M 8/0662

(52) U.S. Cl. CPC H01M 8/04951; H01M 8/0662; H01M 8/04641

(57) ABSTRACT

A fuel cell system includes a controller configured to execute refreshing control for removing an oxide film on a catalyst during an operation of a fuel cell, and an impedance measurer configured to measure an impedance of the fuel cell during the operation of the fuel cell. The impedance measurer executes a calculation process for calculating the impedance by using measurement values of a current and a voltage of the fuel cell in a predetermined measurement time, and outputs a substitute value prepared in advance as the impedance when the start of the refreshing control during the measurement time is detected.

### INCORPORATION BY REFERENCE

The disclosure of Japanese Patent Application No. 2019-160925 filed on Sep. 4, 2019 including the specification, drawings and abstract is incorporated herein by reference in its entirety.

### BACKGROUND

### 1. Technical Field

The present disclosure relates to a fuel cell system and a method for controlling the fuel cell system.

### 2. Description of Related Art

Fuel cells generally have catalysts for promoting electrochemical reaction of reactive gases. The performance of the catalyst decreases when an oxide film is generated on the surface of the catalyst. In fuel cell systems, refreshing control may be executed to remove the oxide film on the catalyst during an operation of the fuel cell. For example, Japanese Unexamined Patent Application Publication No. 2012-185968 (JP 2012-185968 A) describes a fuel cell system configured to execute refreshing control for removing an oxide film on a catalyst by sweeping a current of a fuel cell to reduce a voltage of the fuel cell below an oxidation-reduction potential of the catalyst.

In some fuel cell systems, the impedance of the fuel cell is measured in order to determine a wet state in the fuel cell. The impedance of the fuel cell is generally measured by an alternating current (AC) impedance method. In the AC impedance method, the impedance is calculated by performing Fourier transform for a current and a voltage of the fuel cell that are measured while an alternating current is flowing through the fuel cell.

### SUMMARY

When the refreshing control described above is executed during the measurement of the impedance of the fuel cell, the values of the current and the voltage of the fuel cell temporarily fluctuate greatly. Thus, the impedance measurement result may deviate from an impedance indicating an actual wet state of the fuel cell.

The technology disclosed herein can be implemented in the following aspects.

(1) A first aspect of the present disclosure relates to a fuel cell system. The fuel cell system of the first aspect includes a fuel cell, a controller, and an impedance measurer. The fuel cell is configured to generate electricity through electrochemical reaction of reactive gases. The fuel cell has a catalyst configured to promote the electrochemical reaction. The controller is configured to control an operation of the fuel cell and execute refreshing control for reducing a voltage of the fuel cell by sweeping a current of the fuel cell so as to remove an oxide film on the catalyst during the operation of the fuel cell. The impedance measurer is configured to measure an impedance of the fuel cell during the operation of the fuel cell. The impedance measurer is configured to execute a calculation process for calculating the impedance by using measurement values of the current and the voltage of the fuel cell in a predetermined measurement time, and output a substitute value prepared in advance as the impedance when a start of the refreshing control during the measurement time is detected.

According to the fuel cell system of the first aspect, it is possible to reduce influence of the refreshing control on the measurement result of the impedance of the fuel cell. Thus, it is possible to reduce the occurrence of a case where the impedance measurement result deviates from an impedance indicating the actual wet state of the fuel cell due to the influence of the refreshing control.

(2) The impedance measurer may be configured to output, as the substitute value, a previous value of the impedance calculated through the calculation process before the refreshing control is executed.

According to this configuration, an impedance indicating the wet state of the fuel cell immediately before the refreshing control is executed is output as the substitute value. Thus, it is possible to reduce the occurrence of a case where a substitute value deviating from that indicating the actual wet state of the fuel cell is output.

(3) The impedance measurer may be configured to discard measurement values of the current and the voltage of the fuel cell that are measured during execution of the refreshing control.

According to this configuration, it is possible to reduce the occurrence of a case where the impedance of the fuel cell is calculated based on the measurement values of the current and the voltage of the fuel cell that are influenced by the refreshing control.

(4) The impedance measurer may be configured to continue to output the substitute value as the impedance calculated through the calculation process until at least one of the following conditions is satisfied after the refreshing control is executed: (i) a stoichiometric ratio of an oxidant gas included in the reactive gases in the fuel cell is equal to or larger than a predetermined reference value, (ii) a current-voltage characteristic of the fuel cell does not decrease below a predetermined reference, and (iii) a predetermined elapsed time elapses.

According to this configuration, it is possible to reduce the occurrence of a case where the impedance is calculated based on the measurement values of the current and the voltage of the fuel cell before the fuel cell is recovered to a normal state after the refreshing control is executed. Thus, it is possible to further reduce the influence of the refreshing control on the measurement result of the impedance of the fuel cell.

The technology disclosed herein may be implemented in various aspects other than the fuel cell system. For example, the technology disclosed herein may be implemented in various aspects such as a method for controlling a fuel cell system, a method for detecting a wet state of a fuel cell, a control device or a computer program for implementing those methods, and a non-transitory recording medium storing the computer program. Further, the technology disclosed herein may be implemented in an aspect such as a vehicle including a fuel cell system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating the configuration of a fuel cell system;

FIG. 2A is a schematic functional block diagram of an impedance measurer;

FIG. 2B is a schematic diagram for describing a calculation process to be performed by the impedance measurer;

FIG. 2C is an explanatory drawing illustrating an equivalent circuit of a proton exchange membrane of a fuel cell;

FIG. 3 is an explanatory drawing illustrating a flow of system control to be executed in the fuel cell system;

FIG. 4 is an explanatory drawing illustrating a flow of an impedance measurement process of a first embodiment;

FIG. 5 is an explanatory drawing illustrating an example of execution timings of the impedance measurement process and refreshing control in the first embodiment;

FIG. 6 is an explanatory drawing illustrating a flow of an impedance measurement process of a second embodiment;

FIG. 7 is an explanatory drawing illustrating a process of discarding measurement data stored in buffer areas;

FIG. 8 is an explanatory drawing illustrating a flow of an impedance measurement process of a third embodiment;

FIG. 9A is an explanatory drawing illustrating a change in a current of the fuel cell and a change in a stoichiometric ratio of an oxidant gas during execution of the refreshing control; and

FIG. 9B is an explanatory drawing illustrating a change in a current-voltage characteristic of the fuel cell through the refreshing control.

### DETAILED DESCRIPTION OF EMBODIMENTS

### 1. First Embodiment

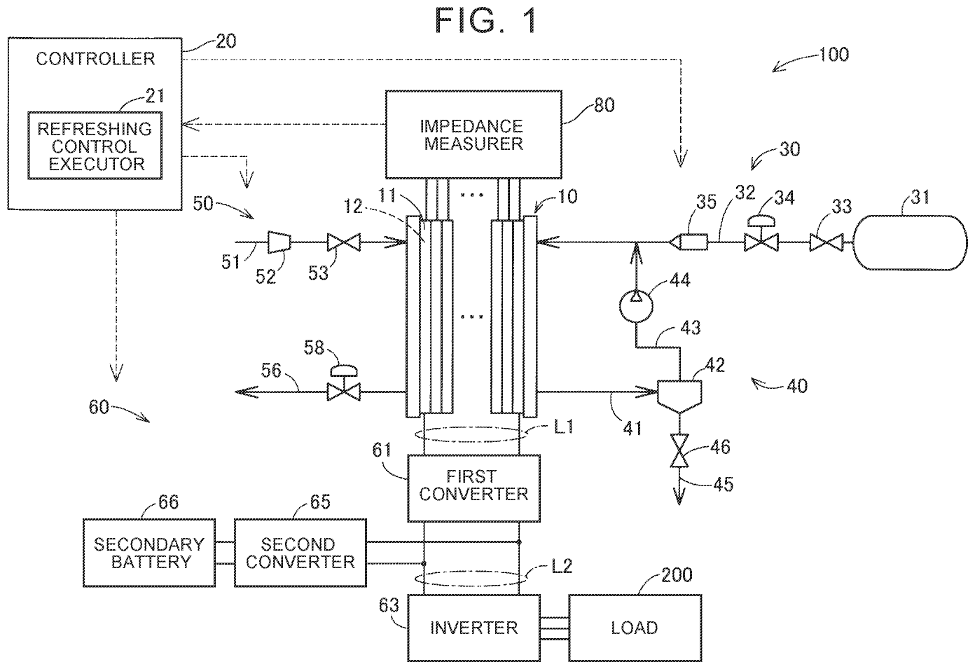

FIG. 1 is a schematic diagram illustrating the configuration of a fuel cell system 100 of a first embodiment. For example, the fuel cell system 100 of the first embodiment is mounted on a vehicle. The fuel cell system 100 includes a fuel cell 10 configured to generate electricity by being supplied with a fuel gas and an oxidant gas as reactive gases. The fuel cell system 100 supplies electric power generated by the fuel cell 10 to a load 200 mounted on the vehicle. Examples of the load 200 include a drive motor serving as a drive source of the vehicle, electrical equipment and auxiliary devices of the vehicle, and connectors for use in external power supply.

The fuel cell 10 is a polymer electrolyte fuel cell configured to generate electricity through electrochemical reaction between a fuel gas and an oxidant gas. In the first embodiment, the fuel gas is hydrogen, and the oxidant gas is oxygen. The fuel cell 10 has a stack structure including a plurality of stacked single cells 11. Each single cell 11 is an electric power generation element configured to generate electricity solely, and includes a membrane-electrode assembly and two separators. The membrane-electrode assembly is a generator having electrodes arranged on respective sides of a proton exchange membrane. The separators sandwich the membrane-electrode assembly. The proton exchange membrane is a polymer electrolyte membrane having excellent proton conductivity in a wet state in which moisture is contained inside. Catalysts 12 are arranged in the electrodes to promote the electrochemical reaction of the reactive gases. Examples of the catalyst 12 include platinum (Pt). Illustration of the components of each single cell 11 is omitted.

The fuel cell system 100 includes a controller 20 configured to control an operation of the fuel cell 10. The controller 20 is an electronic control unit (ECU) including at least one processor and a main memory. The controller 20 exerts various functions for controlling the operation of the fuel cell 10 by the processor executing commands and programs read on the main memory. At least a part of the functions of the controller 20 may be implemented by a hardware circuit.

The controller 20 functions as a refreshing control executor 21. The refreshing control executor 21 executes refreshing control for recovering the performance of the catalysts 12 of the fuel cell 10 during the operation of the fuel cell 10. The refreshing control is described later.

The fuel cell system 100 includes a fuel gas supply unit 30, a fuel gas circulation-discharge unit 40, and an oxidant gas supply-discharge unit 50 as components configured to supply and discharge reactive gases to and from the fuel cell 10.

The fuel gas supply unit 30 supplies a fuel gas to an anode of the fuel cell 10. The fuel gas supply unit 30 includes a tank 31, a fuel gas pipe 32, a main stop valve 33, a regulator 34, and a supply device 35. The tank 31 stores a high-pressure fuel gas. The fuel gas pipe 32 connects the tank 31 and an anode inlet of the fuel cell 10. The main stop valve 33, the regulator 34, and the supply device 35 are provided on the fuel gas pipe 32 in this order from an upstream side that is the tank 31 side.

The main stop valve 33 is a solenoid valve to be opened and closed under control of the controller 20. The main stop valve 33 controls a flow of the fuel gas out of the tank 31. The regulator 34 is a pressure reducing valve configured to adjust a pressure in the fuel gas pipe 32 on an upstream side of the supply device 35 under control of the controller 20. The supply device 35 is periodically opened or closed to send the fuel gas to the fuel cell 10. Examples of the supply device 35 include an injector, which is an electromagnetically driven on-off valve to be opened or closed in every preset drive period. The controller 20 adjusts the amount of fuel gas to be supplied to the fuel cell 10 by controlling the drive period of the supply device 35.

The fuel gas circulation-discharge unit 40 circulates, through the fuel cell 10, a fuel gas contained in an exhaust gas discharged from the anode of the fuel cell 10, and discharges drain water contained in the exhaust gas to the outside of the fuel cell system 100. The fuel gas circulation-discharge unit 40 includes an exhaust gas pipe 41, a gas-liquid separator 42, a circulation pipe 43, a circulation pump 44, a drain pipe 45, and a drain valve 46. The exhaust gas pipe 41 is connected to an anode outlet of the fuel cell 10 and the gas-liquid separator 42, and guides an anode-side exhaust gas to the gas-liquid separator 42. The anode-side exhaust gas contains drain water and a fuel gas that is not used for power generation in the anode.

The gas-liquid separator 42 separates a gas component and a liquid component from the exhaust gas flowing into the gas-liquid separator 42 through the exhaust gas pipe 41, and stores the liquid component as drain water in a liquid state. The gas-liquid separator 42 is connected to the circulation pipe 43. The circulation pipe 43 connects the gas-liquid separator 42 and a part of the fuel gas pipe 32 on a downstream side of the supply device 35. The circulation pipe 43 is provided with the circulation pump 44. The gas-liquid separator 42 guides the gas component separated from the exhaust gas to the circulation pipe 43. The circulation pump 44 sends, to the fuel gas pipe 32, the gas component guided to the circulation pipe 43 and containing the fuel gas.

The drain pipe 45 is connected to a reservoir of the gas-liquid separator 42 that stores drain water. The drain pipe 45 is provided with the drain valve 46 to be opened and closed under control of the controller 20. The controller 20 normally closes the drain valve 46, and opens the drain valve 46 at a predetermined timing to discharge the drain water stored in the gas-liquid separator 42 to the outside of the fuel cell system 100 through the drain pipe 45.

The oxidant gas supply-discharge unit 50 supplies oxygen to the fuel cell 10 as an oxidant gas. Oxygen is contained in air taken into the vehicle through, for example, a front grille of the vehicle. The oxidant gas supply-discharge unit 50 includes a supply pipe 51, a compressor 52, and an on-off valve 53. The supply pipe 51 is connected to a cathode inlet of the fuel cell 10. The compressor 52 and the on-off valve 53 are provided on the supply pipe 51. The compressor 52 compresses intake air into a compressed gas, and sends the compressed gas to the cathode of the fuel cell 10 through the supply pipe 51. The on-off valve 53 is normally closed, and is opened by a pressure of the compressed gas sent from the compressor 52 to permit the compressed gas to flow into the fuel cell 10.

The oxidant gas supply-discharge unit 50 discharges an exhaust gas discharged from the cathode of the fuel cell 10 to the outside of the fuel cell system 100. The oxidant gas supply-discharge unit 50 includes an exhaust gas pipe 56 and a pressure regulating valve 58. The exhaust gas pipe 56 is connected to a cathode outlet, and guides the exhaust gas discharged from the cathode of the fuel cell 10 to the outside of the vehicle. The pressure regulating valve 58 is provided on the exhaust gas pipe 56, and adjusts a back pressure on the cathode side of the fuel cell 10 under control of the controller 20.

The fuel cell system 100 includes a first converter 61, an inverter 63, a second converter 65, and a secondary battery 66 as components configured to control electric power to be supplied to the load 200. The fuel cell 10 is connected to an input terminal of the first converter 61 via first direct current (DC) conductive wires L1. The first converter 61 steps up an output voltage of the fuel cell 10 under control of the controller 20.

An output terminal of the first converter 61 is connected to a DC terminal of the inverter 63 via second DC conductive wires L2. The load 200 is connected to an AC terminal of the inverter 63. The inverter 63 executes DC-AC conversion.

The secondary battery 66 is connected to the second DC conductive wires L2 via the second converter 65. Examples of the secondary battery 66 include a lithium ion battery. The secondary battery 66 stores a part of the electric power generated by the fuel cell 10, and regenerative electric power that is generated in the load 200. The secondary battery 66 functions as an electric power source of the fuel cell system 100 together with the fuel cell 10 under control of the controller 20.

The controller 20 controls the two converters 61 and 65 to control an output current of the fuel cell 10 and charging and discharging of the secondary battery 66. Further, the controller 20 controls three-phase AC frequencies and voltages to be supplied to the load 200 by using the inverter 63.

The fuel cell system 100 further includes an impedance measurer 80. The impedance measurer 80 measures the impedance of the fuel cell 10 by an AC impedance method during the operation of the fuel cell 10. In the first embodiment, the impedance measurer 80 measures the impedance of each single cell 11 of the fuel cell 10. The impedance measurer 80 outputs an impedance measurement result to the controller 20. The controller 20 detects a wet state of each proton exchange membrane of the fuel cell 10 based on the impedance value output from the impedance measurer 80, and controls the operation based on the wet state. The impedance measurer 80 may be incorporated in the first converter 61.

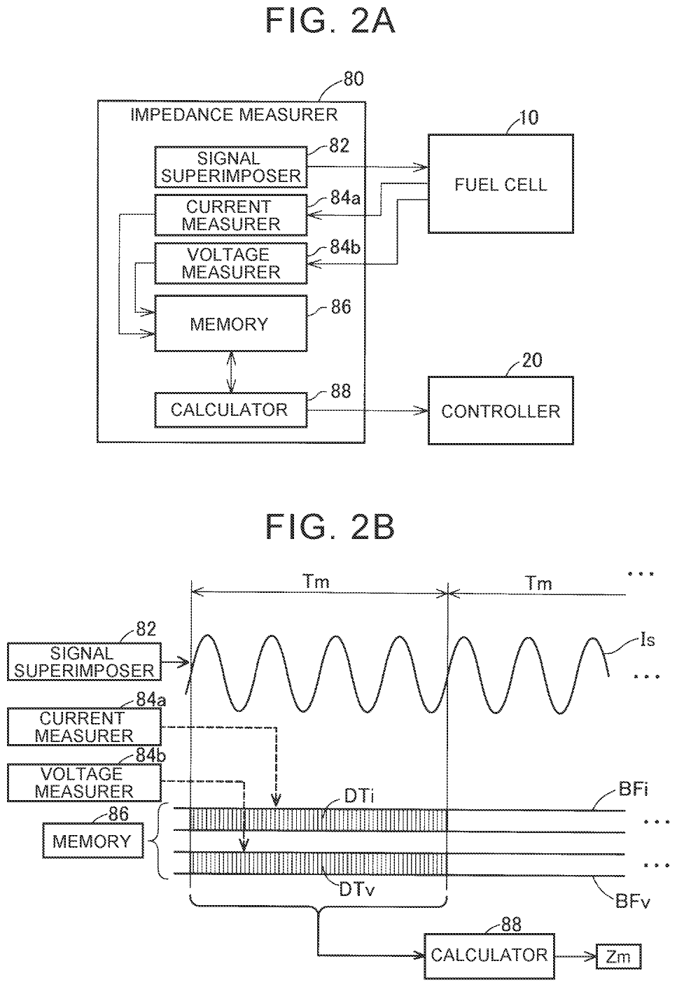

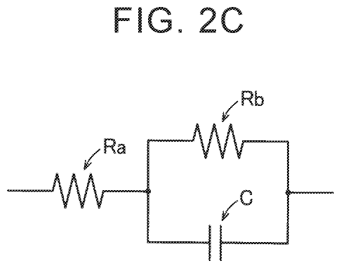

FIG. 2A is a schematic functional block diagram of the impedance measurer 80. The impedance measurer 80 includes a signal superimposer 82, a current measurer 84a, a voltage measurer 84b, a memory 86, and a calculator 88. The signal superimposer 82 includes an AC power supply, and superimposes a sinusoidal alternating current on an output current of the fuel cell 10 during the operation of the fuel cell 10. For example, the frequency of the sinusoidal alternating current may be about 0.1 to 1.5 KHz.

The current measurer 84a measures an output current of the fuel cell 10. The voltage measurer 84b measures an output voltage of the fuel cell 10. The memory 86 stores measurement results from the current measurer 84a and the voltage measurer 84b. In the first embodiment, the memory 86 stores a calculation result from the calculator 88 for use as a substitute value described later.

The calculator 88 executes a calculation process for calculating an impedance by using measurement values of a current and a voltage of the fuel cell 10, which are stored in the memory 86. The calculator 88 outputs the impedance calculated through the calculation process to the controller 20. Although details are described later, the calculator 88 may output a substitute value stored in the memory 86 to the controller 20 in place of the impedance calculated through the calculation process after the refreshing control executor 21 executes the refreshing control.

FIG. 2B is a schematic diagram for describing the calculation process to be executed by the calculator 88 of the impedance measurer 80. While the signal superimposer 82 is superimposing the alternating current during the operation of the fuel cell 10, the current measurer 84a and the voltage measurer 84b measure a current and a voltage of the fuel cell 10 in predetermined measurement periods, and the memory 86 stores each current and voltage in time series. Current measurement data DTi, which is a measurement result from the current measurer 84a, is stored in a current value buffer area BFi of the memory 86. Voltage measurement data DTv, which is a measurement result from the voltage measurer 84b, is stored in a voltage value buffer area BFv of the memory 86. The memory 86 stores pieces of measurement data DTi and DTv for at least a measurement time Tm described later, and pieces of old data are overwritten sequentially.

In every predetermined impedance measurement period, the calculator 88 calculates an impedance Zm by using measurement values of the current and the voltage of the fuel cell 10 during a predetermined length of the measurement time Tm up to a current time point. The measurement time Tm is a time corresponding to several periods to several tens of periods of the alternating current superimposed by the signal superimposer 82. The calculator 88 calculates the impedance Zm by performing Fourier transform for the current of the fuel cell 10 that is contained in the current measurement data DTi during the measurement time Tm and the voltage contained in the voltage measurement data DTv during the measurement time Tm and extracting a measurement target frequency component. Thus, a current impedance Zm of the fuel cell 10 can be measured while reducing influence of changes in the current and the voltage during a normal operation of the fuel cell 10. The measurement time Tm may be regarded as a measurement time of the impedance Zm.

FIG. 2C is an explanatory drawing illustrating an equivalent circuit of the proton exchange membrane of the fuel cell 10. The proton exchange membrane of the fuel cell system 100 is represented by an equivalent circuit in which a reaction resistance Rb and an electric double layer C are connected in parallel to a subsequent stage of a solution resistance Ra. The impedance Zm calculated through the calculation process performed by the calculator 88 indicates the resistance of the proton exchange membrane, and corresponds to a resistance value of the solution resistance Ra.

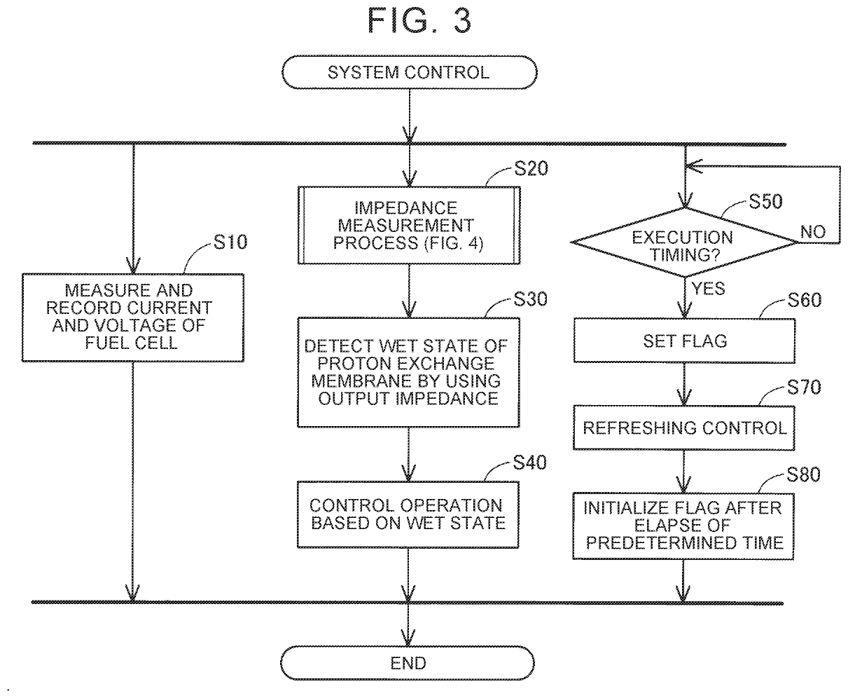

FIG. 3 is an explanatory drawing illustrating a flow of system control to be executed in the fuel cell system 100 under control of the controller 20. In this system control, a process of Step S10, processes of Steps S20 to S40, and processes of Steps S50 to S80 are repeated in parallel in their control periods during the operation of the fuel cell 10.

In Step S10, the impedance measurer 80 causes the current measurer 84a and the voltage measurer 84b to measure a current and a voltage of the fuel cell 10 while the signal superimposer 82 is supplying an alternating current to the fuel cell 10, and records measurement values in the memory 86. Step S10 is repeated in every predetermined measurement period described above throughout the operation of the fuel cell 10.

The processes of Steps S20 to S40 are repeated in every impedance measurement period described above. In the first embodiment, the length of the impedance measurement period in which an impedance measurement process of Step S20 is executed is equal to or longer than the measurement time Tm. In other embodiments, the length of the impedance measurement period may be equal to or shorter than the measurement time Tm.

In Step S20, the controller 20 causes the impedance measurer 80 to execute the impedance measurement process, and acquires a current impedance of the fuel cell 10. The impedance measurement process is described later.

In Step S30, the controller 20 detects the wetness of the proton exchange membrane of the fuel cell 10 by using the impedance output from the impedance measurer 80 in Step S20. The controller 20 stores, in its storage (not illustrated), a map that defines a relationship in which the impedance of the fuel cell 10 and the wetness of the proton exchange membrane are uniquely associated with each other. The controller 20 refers to the map to acquire the wetness of the proton exchange membrane relative to the impedance measured in Step S20.

In Step S40, the controller 20 controls the operation based on the wetness of the proton exchange membrane that is detected in Step S30. As the operation control of Step S40, the controller 20 executes, for example, a limitation process for limiting the output current of the fuel cell 10 when the wetness of the proton exchange membrane is lower than a predetermined threshold. As the operation control of Step S40, the controller 20 may execute, for example, a process of reducing an operation temperature of the fuel cell 10 in order to increase the wetness of the proton exchange membrane as the wetness of the proton exchange membrane decreases. As the operation control of Step S40, the controller 20 may execute control for increasing an execution time of a scavenging process for scavenging the fuel cell 10 as the wetness of the proton exchange membrane increases.

Steps S50 to S80 are processes to be repeated by the refreshing control executor 21 during the operation of the fuel cell 10. In Step S50, the refreshing control executor 21 determines whether a refreshing control execution condition is satisfied. For example, the refreshing control executor 21 determines that the refreshing control execution condition is satisfied when a predetermined time elapses from previous execution of the refreshing control. The refreshing control executor 21 may determine that the refreshing control execution condition is satisfied also when an intermittent operation is switched to the normal operation. The intermittent operation is an operation of reducing the amount of oxidant gas supply as compared to that in the normal operation by setting the output current of the fuel cell 10 to zero and intermittently supplying the oxidant gas to the fuel cell 10.

The refreshing control executor 21 repeats Step S50 and waits until the refreshing control execution condition is satisfied. When determination is made in Step S50 that the refreshing control execution condition is satisfied, the refreshing control executor 21 sets a flag indicating a refreshing control start record in Step S60. The flag is stored at a predetermined address in a memory (not illustrated) of the controller 20. In Step S70, the refreshing control executor 21 executes the refreshing control.

In the refreshing control, the refreshing control executor 21 sweeps the output current of the fuel cell 10 to reduce the voltage of the fuel cell 10 below an oxidation-reduction potential of the catalyst 12, and then immediately reduces the current of the fuel cell 10 to recover a voltage before the refreshing control. In the refreshing control, a time in which the voltage is temporarily reduced may be, for example, about 50 to 300 ms. Through the refreshing control, an oxide film on the catalyst 12 can be removed, and the performance of the catalyst 12 can be recovered. After the refreshing control is executed in Step S70, the refreshing control executor 21 initializes the flag in Step S80.

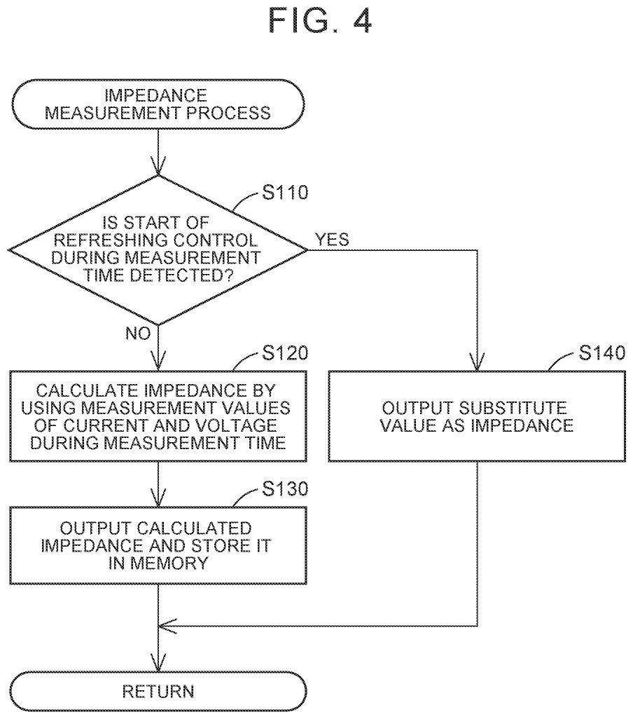

FIG. 4 is an explanatory drawing illustrating a flow of the impedance measurement process of Step S20 of FIG. 3. In Step S110, the impedance measurer 80 detects whether the refreshing control is started during an immediately preceding measurement time Tm. The impedance measurer 80 checks whether the refreshing control executor 21 sets a flag indicating a refreshing control start record. When the flag is set, the impedance measurer 80 determines that the refreshing control is executed during the immediately preceding measurement time Tm. As described above, the flag is set immediately before the start of the refreshing control, and therefore determination is made that the refreshing control is executed during the measurement time Tm even if the refreshing control is being executed at the time of determination in Step S110.

When the start of the refreshing control during the measurement time Tm is not detected in Step S110, the impedance measurer 80 executes a process of Step S120. In Step S120, the calculator 88 of the impedance measurer 80 calculates an impedance Zm by using measurement values of a current and a voltage of the fuel cell 10 that are measured by the current measurer 84a and the voltage measurer 84b during the immediately preceding measurement time Tm as described above.

In Step S130, the impedance measurer 80 outputs the impedance Zm calculated through the calculation process of Step S120 to the controller 20. In the first embodiment, the impedance measurer 80 stores the impedance Zm at a predetermined address in the memory 86 in Step S130. Thus, the impedance measurement process of Step S20 of FIG. 3 is finished. The controller 20 controls the operation in Steps S30 to S40 of FIG. 3 by using the impedance Zm output from the impedance measurer 80.

When the start of the refreshing control during the measurement time Tm is detected in Step S110, the impedance measurer 80 outputs, in Step S140, a substitute value prepared in advance to the controller 20 as a current value of the impedance. The substitute value is a predetermined value indicating an impedance during the normal operation of the fuel cell 10.

The “normal operation of the fuel cell 10” means an operation for generating electricity in the fuel cell 10 in an amount depending on target electric power to be output from the fuel cell system 100 to the load 200. Thus, the normal operation of the fuel cell 10 does not include the operation of the fuel cell 10 during the execution of the refreshing control.

In the first embodiment, the substitute value is a previous value calculated by the impedance measurer 80 through the calculation process of Step S120 and stored in the memory 86 in Step S130 in a previous impedance measurement period. Thus, the impedance measurement process of Step S20 of FIG. 3 is finished, and the controller 20 controls the operation in Steps S30 to S40 of FIG. 3 by using the substitute value output from the impedance measurer 80.

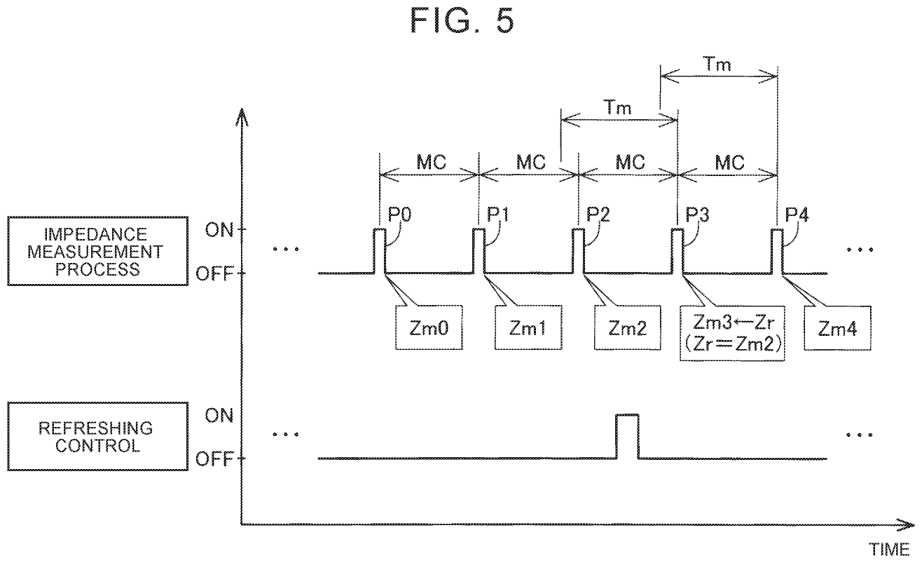

FIG. 5 is a timing chart illustrating an example of execution timings of the impedance measurement process and the refreshing control. In FIG. 5, “ON” means that a process is executed, and “OFF” means that the process is not executed. In this example, impedance measurement processes P0, P1, P2, P3, and P4 are executed in respective measurement periods MC. In this example, the refreshing control is executed once between the impedance measurement processes P2 and P3.

In each of the impedance measurement processes P0, P1, and P2, the refreshing control is not executed during a immediately preceding measurement time Tm, and measurement values of a current and a voltage of the fuel cell 10 during the measurement time Tm do not include measurement values during execution of the refreshing control. As described in Steps S120 to S130 of FIG. 4, impedances Zm0, Zm1, and Zm2 are calculated by using the measurement values of the current and the voltage of the fuel cell 10 that are measured during the respective measurement times Tm, and are output to the controller 20.

In the impedance measurement process P3, the refreshing control is executed during an immediately preceding measurement time Tm. As described in Step S140 of FIG. 4, a substitute value Zr is set for the controller 20 as an impedance Zm3 that is a measurement result in the impedance measurement process P3, and is output to the controller 20. In the first embodiment, the substitute value Zr is a previous value, that is, the impedance Zm2 output in the impedance measurement process P2.

In the impedance measurement process P4, the refreshing control is not executed in a immediately preceding measurement time Tm, and measurement values of a current and a voltage of the fuel cell 10 during the measurement time Tm do not include measurement values during execution of the refreshing control. Similarly to the impedance measurement processes P0, P1, and P2, an impedance Zm4 is calculated by using the measurement values of the current and the voltage of the fuel cell 10 that are measured during the immediately preceding measurement time Tm, and is output to the controller 20.

During the execution of the refreshing control, the current and the voltage of the fuel cell 10 fluctuate greatly in a short time as compared to the normal operation of the fuel cell 10. The fluctuation may emerge as noise that is not completely removed by Fourier transform when the impedance is calculated. If the impedance is calculated by using measurement values of the current and the voltage of the fuel cell 10 during the execution of the refreshing control, the value of the impedance may deviate from the value indicating the wet state of the proton exchange membrane of the fuel cell 10.

According to the fuel cell system 100 of the first embodiment, when the refreshing control is started during the impedance measurement time Tm, the substitute value indicating the impedance during the normal operation of the fuel cell 10 is output to the controller 20. This configuration reduces influence of the refreshing control on the measurement result of the impedance of the fuel cell 10 to be output from the impedance measurer 80 to the controller 20, thereby reducing the occurrence of a case where the impedance measurement result deviates from an impedance indicating an actual wet state of the fuel cell due to the influence of the refreshing control. Thus, it is possible to reduce the occurrence of a case where the controller 20 does not appropriately control the operation of the fuel cell 10 based on the impedance of the fuel cell 10 because the wet state of the fuel cell 10 is not grasped accurately. At a timing when the refreshing control is finished, that is, when the impedance of the fuel cell 10 can be measured, the controller 20 may newly start measuring the current and the voltage of the fuel cell 10 in a predetermined measurement period for use in the calculation of the impedance.

According to the fuel cell system 100 of the first embodiment, the impedance measurer 80 outputs, to the controller 20 as the substitute value, the previous value of the impedance calculated through the calculation process before the refreshing control is executed. Therefore, an impedance indicating the wet state of the proton exchange membrane of the fuel cell 10 immediately before the refreshing control is executed is output as the substitute value. This configuration reduces the occurrence of a case where an impedance having a value deviating from that indicating the actual wet state of the proton exchange membrane of the current fuel cell 10 is output as the substitute value.

### 2. Second Embodiment

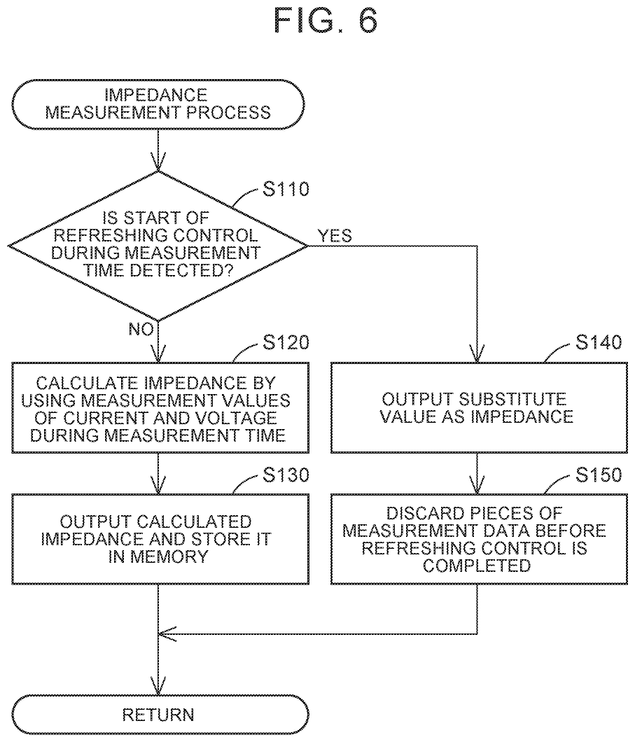

FIG. 6 is an explanatory drawing illustrating a flow of an impedance measurement process of a second embodiment. The impedance measurement process of the second embodiment is executed in a fuel cell system 100 having a configuration similar to that described in the first embodiment. The impedance measurement process of the second embodiment is substantially the same as the impedance measurement process of the first embodiment except that a process of Step S150 is added. In the second embodiment, the measurement time Tm is longer than the impedance measurement period.

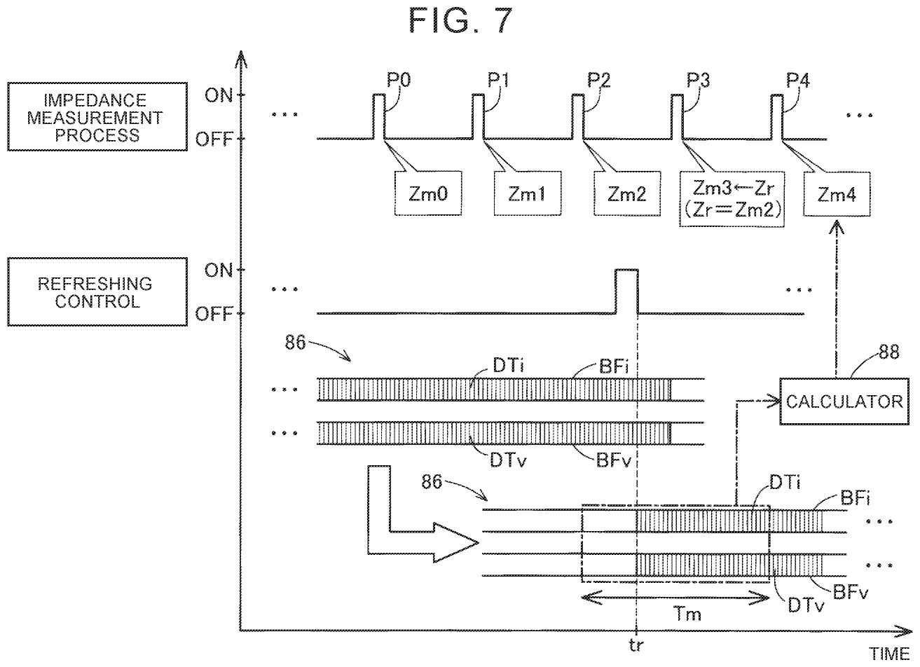

Details of the process of Step S150 are described with reference to FIG. 7. In FIG. 7, a schematic diagram illustrating changes in the buffer areas BFi and BFv of the memory 86 before and after Step S150 is added to the timing chart of FIG. 5.

After a substitute value is output to the controller 20 in Step S140, the impedance measurer 80 discards, in Step S150, at least pieces of data measured during the execution of the refreshing control from the pieces of measurement data DTi and DTv stored in the buffer areas BFi and BFv of the memory 86. In the second embodiment, pieces of measurement data DTi and DTv before a time tr when the refreshing control is completed are deleted from the buffer areas BFi and BFv as illustrated in FIG. 7. In the impedance measurement process after the process of Step S150, the calculator 88 calculates an impedance by using only measurement values of a current and a voltage of the fuel cell 10 that are measured after the refreshing control is completed as illustrated in FIG. 7. In other embodiments, only pieces of measurement data DTi and DTv acquired during the execution of the refreshing control may be deleted from the buffer areas BFi and BFv, and pieces of measurement data DTi and DTv before the start of the refreshing control may be left in the buffer areas BFi and BFv.

According to the impedance measurement process of the second embodiment, the measurement values of the current and the voltage of the fuel cell 10 that are influenced by the refreshing control are deleted from the buffer areas BFi and BFv of the memory 86. This configuration further reduces the occurrence of a case where an impedance is calculated by using the measurement values influenced by the refreshing control. Further, the fuel cell system of the second embodiment can attain various actions and effects similar to those described in the first embodiment.

### 3. Third Embodiment

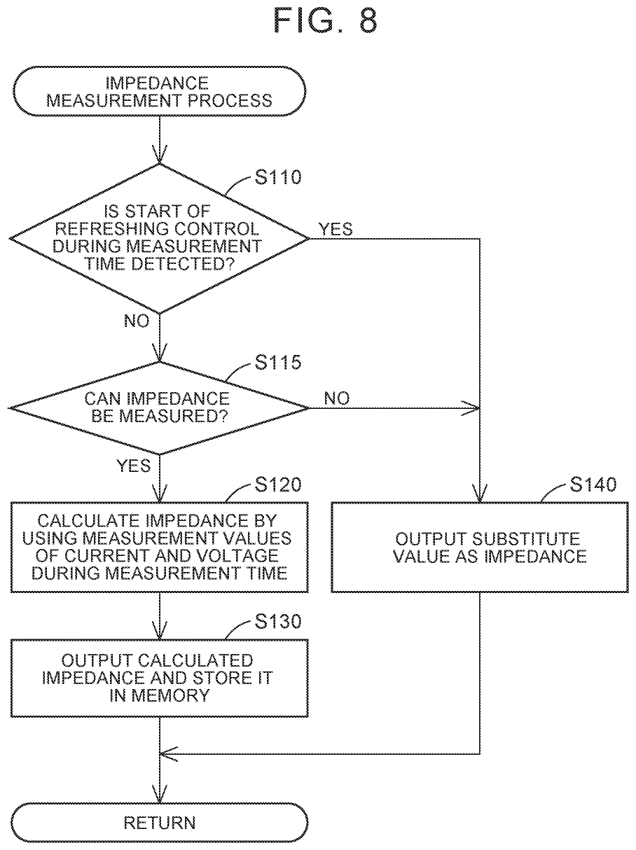

FIG. 8 is an explanatory drawing illustrating a flow of an impedance measurement process of a third embodiment. The impedance measurement process of the third embodiment is executed in a fuel cell system 100 having a configuration similar to that described in the first embodiment. The impedance measurement process of the third embodiment is substantially the same as the impedance measurement process of the first embodiment except that a determination process of Step S115 is added.

Similarly to the first embodiment, the impedance measurer 80 determines in Step S110 whether there is a record of the start of the refreshing control during a immediately preceding measurement time Tm. When the refreshing control start record is detected, the impedance measurer 80 outputs a substitute value to the controller 20 in Step S140.

When the refreshing control start record is not detected, the impedance measurer 80 determines in Step S115 whether an impedance can be measured. The impedance measurer 80 determines that an impedance can be measured when any one of the following conditions (i) to (iii) is satisfied. The following conditions (i) to (iii) are provided to ensure that the fuel cell 10 is not influenced by the refreshing control. That is, the conditions (i) to (iii) may be regarded as conditions for determining whether the fuel cell 10 after the refreshing control is recovered to the state in the normal operation in which the impedance can be measured normally.

Conditions for Determining That Impedance Can Be Measured

(i) The stoichiometric ratio of the reactive gas in the fuel cell 10 is equal to or larger than a predetermined reference value.

(ii) The current-voltage characteristic of the fuel cell 10 has not been decreased below a predetermined reference.

(iii) A predetermined elapsed time has elapsed from completion of the refreshing control.

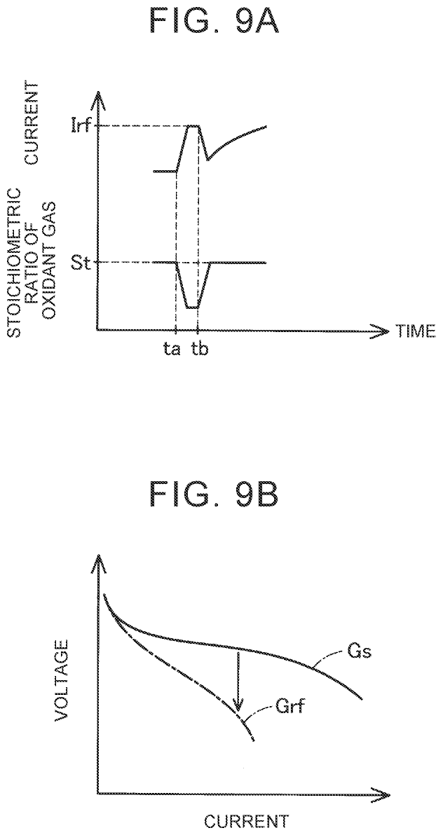

The condition (i) is described with reference to FIG. 9A. FIG. 9A is an example of a timing chart illustrating a change in the current of the fuel cell 10 and a change in the stoichiometric ratio of the oxidant gas in the fuel cell 10 during the execution time of the refreshing control. The “stoichiometric ratio of the oxidant gas” in the fuel cell 10 is the ratio of the amount of an actually supplied oxidant gas to the amount of an oxidant gas theoretically necessary to generate electricity in the fuel cell 10. The impedance measurer 80 calculates the stoichiometric ratio of the oxidant gas based on the amount of the oxidant gas supplied to the fuel cell 10 and the amount of electricity generated in the fuel cell 10.

In the example of FIG. 9A, the refreshing control is executed in a period from a time ta to a time tb. In the period from the time ta to the time tb, the current of the fuel cell 10 is temporarily swept to a current value Irf in order to reduce the voltage of the fuel cell 10 to the oxidation-reduction potential of the catalyst. After the time tb at which the refreshing control is completed, the fuel cell 10 returns to the normal operation, and therefore the current of the fuel cell 10 decreases sharply.

In the period from the time ta to the time tb during which the refreshing control is executed, the oxidant gas is sharply consumed at the cathode of the fuel cell 10 in order to sweep the current of the fuel cell 10 through the refreshing control. Therefore, the stoichiometric ratio of the oxidant gas significantly decreases from a stoichiometric ratio St in the normal operation of the fuel cell 10. After the time tb at which the refreshing control is completed, the stoichiometric ratio of the oxidant gas returns to the stoichiometric ratio St in the normal operation of the fuel cell 10 through the supply of the oxidant gas by the oxidant gas supply-discharge unit 50. When the stoichiometric ratio of the oxidant gas returns to the stoichiometric ratio St in the normal operation of the fuel cell 10, the current of the fuel cell 10 is recovered to a current in the normal operation. When the condition (i) is satisfied, the impedance can be measured while reducing the influence of the refreshing control. When the condition (i) is satisfied, this configuration reduces the occurrence of a case where the impedance of the fuel cell 10 is calculated as a value deviating from that indicating the actual wet state of the proton exchange membrane of the fuel cell 10.

The condition (ii) is described with reference to FIG. 9B. FIG. 9B illustrates a graph Gs showing a current-voltage characteristic during the normal operation of the fuel cell 10, and a graph Grf showing a current-voltage characteristic of the fuel cell 10 immediately after the refreshing control is executed. Immediately after the refreshing control is completed, the stoichiometric ratio of the oxidant gas decreases as described above, and the current-voltage characteristic of the fuel cell 10 decreases below a current-voltage characteristic during the normal operation. As illustrated in FIG. 9B, the decrease in the current-voltage characteristic of the fuel cell 10 means a state in which the value of the voltage uniquely determined relative to the current decreases. When the impedance of the fuel cell 10 is measured in this state, the measurement value may be obtained as a value deviating from that indicating the actual wet state of the proton exchange membrane of the fuel cell 10. When the current-voltage characteristic of the fuel cell 10 does not decrease below the predetermined reference based on the current-voltage characteristic of the fuel cell 10 during the normal operation, the fuel cell 10 is not influenced by the refreshing control. When the condition (ii) is satisfied, this configuration reduces the occurrence of a case where the impedance of the fuel cell 10 is calculated as a value deviating from that indicating the actual wet state of the proton exchange membrane of the fuel cell 10.

The condition (iii) is described. The elapsed time in the determination condition (iii) is set by experimentally determining, in advance, a time required until the condition (i) or (ii) is satisfied after the refreshing control is completed. When the condition (iii) is satisfied, the fuel cell 10 is normally operating without being influenced by the refreshing control. When the condition (iii) is satisfied, this configuration reduces the occurrence of a case where the impedance of the fuel cell 10 is calculated as a value deviating from that indicating the actual wet state of the proton exchange membrane of the fuel cell 10.

When any one of the conditions (i) to (iii) is satisfied in Step S115, the impedance measurer 80 executes Step S120 under the assumption that the impedance of the fuel cell 10 can be measured. In this case, the impedance of the fuel cell 10 is calculated by using measurement values of a current and a voltage of the fuel cell 10 during the measurement time Tm. When none of the conditions (i) to (iii) is satisfied in Step S115, the impedance measurer 80 outputs a substitute value to the controller 20 in Step S140.

According to the impedance measurement process of the third embodiment, the impedance measurer 80 continues to output the substitute value as the impedance of the fuel cell 10 until any one of the conditions (i) to (iii) is satisfied after the refreshing control is executed. This configuration reduces the occurrence of a case where the impedance is calculated based on the measurement values of the current and the voltage of the fuel cell 10 before the fuel cell 10 is recovered to the normal state after the refreshing control is executed. Thus, the influence of the refreshing control on the measurement result of the impedance of the fuel cell 10 is further reduced. Further, the fuel cell system 100 of the third embodiment can attain various actions and effects similar to those described in the first embodiment.

### 4. Other Embodiments

For example, various configurations described above in the embodiments may be modified as follows. The following other embodiments are regarded as examples of embodiments for implementing the technology disclosed herein similarly to the embodiments described above.

### Other Embodiment 1

The impedance measurer 80 may output, as the substitute value, a value other than the previous value of the impedance calculated through the calculation process before the refreshing control is executed. The substitute value may be a value prepared in advance and indicating an impedance during the normal operation of the fuel cell 10 in which the refreshing control is not executed. It is only necessary that the substitute value be prepared in advance before use. The substitute value may be a value calculated during the operation of the fuel cell 10, or a value preset at the time of factory shipment of the fuel cell system 100. For example, the impedance measurer 80 may store, in a non-volatile manner, an average impedance in the normal operation of the fuel cell 10, which is determined in advance through experiments, and output the impedance to the controller 20 as the substitute value. The impedance measurer 80 may output a substitute value depending on an operating condition of the fuel cell 10 by using a map in which the experimentally determined impedances and parameters indicating operating conditions of the fuel cell 10 are uniquely associated with each other.

### Other Embodiment 2

In the impedance measurement process of the third embodiment, the process of Step S150 described in the second embodiment may be executed. In this case, pieces of measurement data DTi and DTv before any one of the conditions (i) to (iii) is satisfied in Step S115 may be deleted from the memory 86.

### Other Embodiment 3

In the third embodiment, the determination may be made only on one or two conditions out of the conditions (i) to (iii) in Step S115. Other conditions may be added to the conditions (i) to (iii).

### 5. Others

In the embodiments described above, the functions and processes implemented by software may partially or entirely be implemented by hardware. Further, the functions and processes implemented by hardware may partially or entirely be implemented by software. Examples of hardware include various circuits such as an integrated circuit, a discrete circuit, and a circuit module obtained by combining those circuits.

The technology disclosed herein is not limited to the embodiments described above, but may be implemented by various configurations without departing from the gist of the technology disclosed herein. For example, the technical features of the embodiments corresponding to the technical features of the respective aspects described in the “SUMMARY” section may be replaced or combined as appropriate to solve a part or all of the problems described above or attain a part or all of the effects described above. Any technical feature may be omitted as appropriate unless otherwise described as being essential herein, as well as technical features described as being inessential herein.

What is claimed is:

1. A fuel cell system comprising:
a fuel cell configured to generate electricity through electrochemical reaction of reactive gases, the fuel cell having a catalyst configured to promote the electrochemical reaction;
a controller configured to control an operation of the fuel cell and execute refreshing control for reducing a voltage of the fuel cell by sweeping a current of the fuel cell so as to remove an oxide film on the catalyst during the operation of the fuel cell; and
an impedance measurer configured to measure an impedance of the fuel cell during the operation of the fuel cell, wherein
the impedance measurer is configured to:
execute a calculation process for calculating the impedance by using measurement values of the current and the voltage of the fuel cell in a predetermined measurement time; and
output a substitute value prepared in advance as the impedance when a start of the refreshing control during the predetermined measurement time is detected.

2. The fuel cell system according to claim 1, wherein the impedance measurer is configured to output, as the substitute value, a previous value of the impedance calculated through the calculation process before the refreshing control is executed.

3. The fuel cell system according to claim 1, wherein the impedance measurer is configured to discard measurement values of the current and the voltage of the fuel cell that are measured during execution of the refreshing control.

4. The fuel cell system according to claim 1, wherein the impedance measurer is configured to continue to output the substitute value as the impedance calculated through the calculation process until at least one of a following conditions is satisfied after the refreshing control is executed:
(i) a stoichiometric ratio of an oxidant gas included in the reactive gases in the fuel cell is equal to or larger than a predetermined reference value;
(ii) a current-voltage characteristic of the fuel cell does not decrease below a predetermined reference; and
(iii) a predetermined elapsed time elapses.

5. A method for controlling a fuel cell system, comprising:
executing refreshing control for reducing a voltage of a fuel cell by sweeping a current of the fuel cell so as to remove an oxide film on a catalyst of the fuel cell during an operation of the fuel cell;
executing a calculation process for calculating an impedance of the fuel cell by using measurement values of the current and the voltage of the fuel cell in a predetermined measurement time during the operation of the fuel cell; and
outputting a substitute value prepared in advance as the impedance when a start of the refreshing control during the predetermined measurement time is detected.
